(19) United States
(12) Patent Application Publication
(10) Pub. No.: US 2023/0192289 A1
(43) Pub. Date: Jun. 22, 2023

(54) COOLING SYSTEM AND AIRCRAFT

(71) Applicant: HONDA MOTOR CO.,LTD., Tokyo (JP)

(72) Inventors: Yuichi FUKUCHI, Saitama (JP); Azuki ICHIKAWA, Saitama (JP)

(21) Appl. No.: 18/066,982

(22) Filed: Dec. 15, 2022

(30) Foreign Application Priority Data
Dec. 22, 2021 (JP) 2021-208272

(51) Int. Cl. B64C 29/00; B64D 33/10

(52) U.S. Cl. CPC B64C 29/0091; B64C 29/0025; B64D 33/10; B64D 27/24

(57) ABSTRACT

An aircraft comprises a fuselage, a front wing and a rear wing that extends laterally from the fuselage for generating lift during cruise, a boom extending in a front-back direction supported by these wings to be spaced apart from the fuselage, at least one VTOL rotor supported on the boom and having one or more blades for generating thrust in a vertical direction during take-off and landing, and a cooling system within the boom including two radiators stored between an inlet and an outlet provided on the boom, to cool an element with a low control temperature and an element with a high control temperature, for example, a motor and an inverter, respectively, among electric elements of the at least one VTOL rotor by using a first radiator that is positioned on the inlet side and a radiator that is positioned on the outlet side among the two radiators.

### CROSS-REFERENCE TO RELATED APPLICATIONS

The contents of the following Japanese patent application(s) are incorporated herein by reference:

NO. 2021-208272 filed in JP on Dec. 22, 2021

### BACKGROUND

### 1. Technical Field

The present invention relates to a cooling system and an aircraft.

### 2. Related Art

Conventionally, a vertical take-off and landing type aircraft (also called a vertical take-off and landing aircraft or simply an aircraft) is known which performs take-off and landing by elevating and lowering in a vertical direction with rotors for vertical take-off and landing (VTOL) arranged on the right side and the left side of the fuselage, and flies in a horizontal direction with a cruising rotor arranged on the back portion of the fuselage. In such an aircraft electrical elements such as a controller of the VTOL rotor is cooled by using airflow generated by the VTOL rotor (down wash). For example, Patent Document 1 discloses a cooling system configured to cause heat exchange by guiding the airflow to the heat exchanger within the wing body via an inlet provided on an upper plane of the wing body, and to cool electrical elements of the VTOL rotor by using the heat exchanger. Here, it is required that the electrical elements of the VTOL rotor are efficiently cooled.
Patent Document 1: German Patent No. 102016125656 Specification

### BRIEF DESCRIPTION OF THE DRAWINGS

FIG. 1 illustrates a configuration of an aircraft according to the present embodiment in a top view.

FIG. 2A illustrates an internal configuration of a boom.

FIG. 2B illustrates a configuration of a radiator in a front view.

FIG. 2C illustrates the configuration of the radiator in a side view.

FIG. 2D illustrates an example of a cooling circuit configured by the cooling system.

FIG. 3 illustrates a cross-sectional structure of a airflow guide structure relative to reference line CC in FIG. 2A.

FIG. 4A illustrates a configuration of an upper side of the airflow guide structure and an arrangement of an inlet.

FIG. 4B illustrates a configuration of a lower side of the airflow guide structure and an arrangement of an outlet.

FIG. 5A illustrates another example of the cooling circuit configured by the cooling system.

FIG. 5B illustrates a configuration of a control system of the cooling system.

FIG. 6A illustrates an example of an operation (an operation at the time of ascending) of the cooling circuit of FIG. 5A.

FIG. 6B illustrates an example of an operation (an operation when an abnormality occurs at the time of ascending) of the cooling circuit of FIG. 5A.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to the solution of the invention.

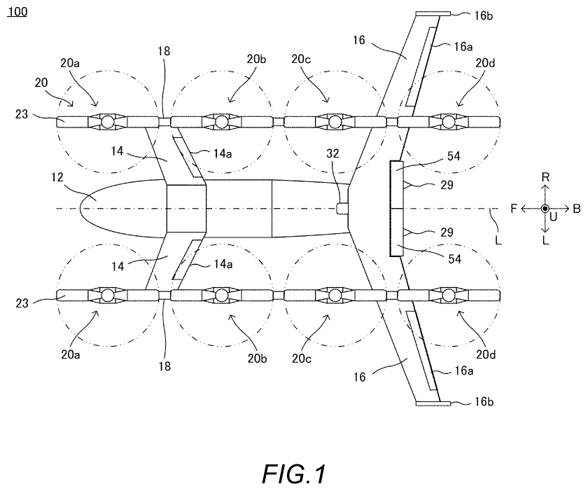

FIG. 1 illustrates a configuration of an aircraft 100 according to the present embodiment in a top view. The aircraft 100 includes a rotor having an electric motor as its driving source, is a vertical take-off and landing aircraft that performs take-off and landing in a vertical direction by using rotors for vertical take-off and landing (VTOL) to generate thrust, as well as flies in a horizontal direction by using a cruising rotor (also called a cruise rotor) to generate thrust, and is a hybrid aircraft that is capable of operating an electric motor with electric power supplied from each of a battery and a motor generator while charging the battery with the motor generator. The aircraft 100 according to the present embodiment includes a cooling system that is capable of efficiently cooling a motor that constitutes the VTOL rotor and control equipment by using the airflow generated by the VTOL rotor in particular (that is, down wash), and the aircraft 100 includes a fuselage 12, a front wing 14, a rear wing 16, two booms 18, eight VTOL rotors 20, two cruising rotors 29, a cooling system 60, and an airflow guide structure 70.

The fuselage 12 is a structure body for providing space for crews and passengers to board and to load cargo or the like, and for storing apparatuses such as the battery or the motor generator (neither are shown). The fuselage 12 is symmetric relative to a central axis L, and has a shape that extends in a front-back direction that is parallel to the central axis L and is thin in the left-right direction that is orthogonal to the central axis L in the horizontal plane. Here, the direction parallel to the central axis L is defined as the front-back direction, in which the left side of the drawing and the right side of the drawing are respectively the front (F) and back (B), and the direction orthogonal to the central axis L in the horizontal plane is defined as the width direction (or the left-right direction), in which the upper side of the drawing and the lower side of the drawing are respectively the right (R) and left (L). In addition, the vertical direction is orthogonal to each of these front-back direction and the width direction, in which the upward and downward in the vertical direction are also respectively referred to as upper (U) and lower (L). The fuselage 12 has a front end with a round curvature in a top view, and a rear end parallel to the width direction that is tapered to some extent relative to the barrel portion.

The front wing 14 is a wing body provided to extend laterally from the fuselage 12, and configured to generate lift during cruise, that is, by moving forward, which functions as a canard of the aircraft 100. The front wing 14 has a V-shape with two wing bodies respectively extending from the center portion to the front-left direction and the front-right direction, and is fixed on the upper portion of the front side of the barrel portion of the fuselage 12 at the center portion with the opening of the V-shaping facing toward the front. The front wing 14 includes elevators 14a arranged on the rear edge in each of the two wing bodies.

The rear wing 16 is a wing body provided to extend laterally from the fuselage 12, and configured to generate lift during cruise, that is, by moving forward, which functions as a swept-back wing configured to reduce air resistance. The rear wing 16 has a V-shape with two wing bodies respectively extending from the center portion to the rear-left direction and the rear-right direction, and is fixed on the upper portion of the rear end of the fuselage 12 at the center portion with the opening of the V-shaping facing toward the back via a pylon 32. The rear wing 16 includes an elevon 16a arranged on the rear edge in each of the two wing bodies, and a vertical tail 16b arranged on a wing end.

Here, the wing area of the rear wing 16 is greater than that of the front wing 14, and the wing width of the rear wing 16 is wider than that of the front wing. In this manner, the lift generated by the rear wing 16 by moving forward is greater than the lift generated by the front wing 14, and the rear wing 16 functions as the main wing of the aircraft 100. Note that, the wing areas, the lengths or the like of the front wing 14 and the rear wing 16 may be defined based on the balance of the lift generated by each wing, the center of gravity, the posture of the aircraft body during cruise, and the like.

The two booms 18 are structure bodies that are supported by the front wing 14 and the rear wing 16 to be spaced apart from the fuselage 12 to the left and to the right, respectively, and functions to support or store each units in the configuration of the VTOL rotor 20 and the cooling system 60 described below. The two booms 18 have a cylindrical shape extending in a front-back direction in a top view and a wing-shaped cross section with the upper side having a round curvature and the lower side tapered in a front view, and are paired to be arranged symmetrically with respect to the fuselage 12 (that is, the central axis L). Note that, the two booms 18 may be formed to extend in the front-back direction and have an arch-shape curvature in the width direction. The two booms 18 have their front side end portions positioned forward of the front wing 14 to be supported by the ends of the front wing 14 at the front side barrel portion (between the two VTOL rotors 20a, 20b on the front side), and have their rear side end portions positioned behind the rear wing 16 to be supported by the rear wing 16 at the rear side barrel portion (between the two VTOL rotors 20c, 20d on the rear side).

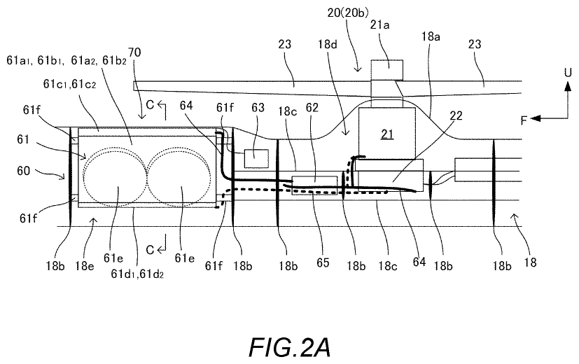

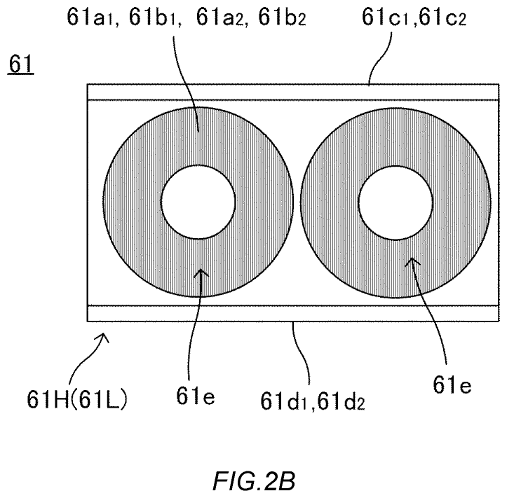

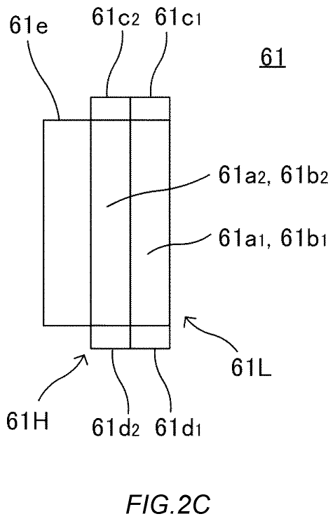

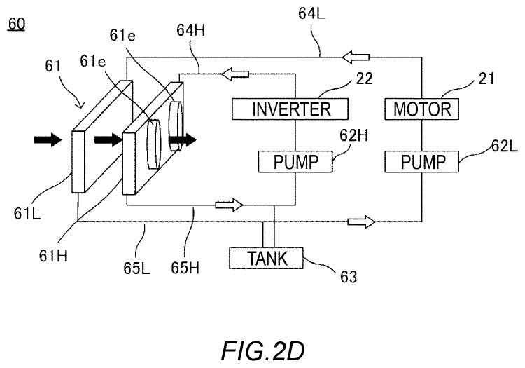

FIG. 2A illustrates an internal configuration of the boom 18. The boom 18 includes a skin 18a, a rib 18b, and a spar 18c. The skin 18a is a member that constitutes the surface of the boom 18, and is molded into a cylindrical shape having a wing-shaped cross section and extending in the front-back direction. The skin 18a rises high above where the VTOL rotor 20 is arranged and spreads in the left-right direction to form a space 18d, and rises to some extent above where the cooling system 60 is arranged and spreads in the left-right direction to form a space 18e. The rib 18b is a wing-shaped plate member, and is arranged in a plurality of locations in the front-back direction to retain the skin 18a from the inside. Note that, the spaces 18d, 18e within the boom 18 are partitioned by the rib 18b. The spar 18c is a bar member that extends in the front-back direction, and constitutes a backbone for supporting the rib 18b and other members.

The eight VTOL rotors 20 (20a to 20d) are rotors that are supported by the two booms 18 to generate thrust in the vertical direction during take-off and landing. Four VTOL rotors 20a to 20d among the eight VTOL rotors 20 are supported at a substantially equal interval by the boom 18 on the left-hand side, and the remaining four VTOL rotors 20a to 20d are supported at a substantially equal interval by the boom 18 on the right-hand side. Here, the VTOL rotor 20a is arranged frontmost, the two VTOL rotors 20b, 20c are arranged to be front and back, respectively, between the front wing 14 and the rear wing 16, and the VTOL rotor 20d is arranged last. Among the VTOL rotors 20a to 20d on the left-hand side and the four VTOL rotors 20a to 20d n the right-hand side, each two VTOL rotors 20a to 20d which are located at the same position relative to the front-back direction form a pair, and are controlled to rotate in reverse directions from each other. Unless stated otherwise, each of the eight VTOL rotors 20a to 20d is referred to simply as the VTOL rotor 20.

The VTOL rotor 20 includes one or more blades 23, a motor 21, and an inverter 22. Note that, the motor 21 and the inverter 22 is also called electrical elements.

The one or more blades 23 are supported on the boom 18 as illustrated in FIG. 2A, and are vane-shaped members that generate thrust in the vertical direction by rotation thereof. In the present embodiment, the number of the blades 23 is two, but it may be any number including one or three or more. The one or more blades 23 are supported at a position higher than the front wing 14 and the rear wing 16. Note that, in FIG. 1, the plane of rotation of the one or more blades 23 of each VTOL rotor 20 is indicated by using two-dot chain lines.

The motor (an example of a rotational apparatus) 21 is an electric motor that includes a rotational axis 21a toward the up-down direction, via which the blade 23 fixed at the end is caused to rotate, and is supported by the spar 18c via a support member to be accommodated in the space 18d of the boom 18.

The inverter (an example of a control apparatus) 22 is an apparatus that receives DC power supply from the battery and converts it to AC power to supply it to the motor 21, and is supported by the spar 18c below the motor 21. The inverter 22 can control the rate of rotation of the motor 21.

The two cruising rotors 29 are rotors that are supported by the rear end of the fuselage 12 to generate thrust during cruise. The cruising rotors 29 are arranged side by side on the left and right to the central axis L in a cylincrial duct 54 fixed to the rear end of the fuselage 12, and have one or more blades that are supported in the duct 54 to generate a forward thrust by rotation thereof, motors that have rotational axes toward the front-back direction, via which the one or more blades fixed to the end are caused to rotate, and inverters that receive DC power supply from the battery and converts it to AC power to supply it to the motor (neither are shown). The inverter can control the rate of rotation of the motor.

The cooling system 60 is a system for cooling, in a liquid cooling manner, the motor 21 and the inverter 22 which constitute the VTOL rotor 20 by using a radiator 61 arranged within the boom 18. Although, in the present embodiment, one cooling system 60 is provided for one VTOL rotor 20, making a total of eight cooling systems 60, it is not limited thereto, and one cooling system 60 may be provided for a plurality of (for example, two) VTOL rotors 20. The cooling system 60 includes the radiator 61, two pumps 62L, 62H, a coolant fluid tank 63, and tubes 64L, 64H, 65L, 65H. Note that, water can be used as the coolant fluid.

FIG. 2B and FIG. 2C illustrate configurations of the radiator 61 in a front view and a side view, respectively. The radiator 61 is a heat exchanger configured to cool the coolant fluid for cooling the motor 21 and the inverter 22, and includes two radiators 61L, 61H, and two fans 61e. Note that, these are supported between the two ribs 18b by using the support member 61f, and are stored in the boom 18 by the airflow guide structure 70 described below. The arrangement in the boom 18 of the radiator 61 will be described below.

The two radiators 61L, 61H respectively includes a plurality of tubes 61a₁, 61a₂ for causing the coolant fluid to flow upward and downward, a plurality of fins 61b₁, 61b₂ that are respectively fixed to the plurality of tubes 61a₁, 61a₂ for increasing the surface area that contact the airflow, upper tanks 61c₁, 61c₂ for sending the coolant fluid to the plurality of tubes 61a₁, 61a₂, and lower tanks 61d₁, 61d₂ for receiving the coolant fluid from the plurality of tubes 61a₁, 61a₂.

The radiator 61L is configured by arranging the plurality of tubes 61a₁ in a horizontal direction, assembling them in a rectangular shape in a front view with the plurality of fins 61b₁, and fixing the upper tank 61c₁ on the upper side thereof and the lower tank 61d₁ on the lower side thereof. The radiator 61L is arranged on an inlet 70a side of the boom 18, as described below, and is connected to an electrical element with low control temperature, for example, a motor 21, among electrical elements of the VTOL rotor 20. Operation of the pump 62L described below causes the coolant fluid having been heated by circling through the motor 21 to be fed to the upper tank 61c₁ via the tube 64L, to be cooled by flowing downward through each of the plurality of tubes 61a₁ and sent to the lower tank 61d₁, and to be sent to the motor 21 via the tube 65L.

Similarly, the radiator 61H is configured by arranging the plurality of tubes 61a₂ in a horizontal direction, assembling them in a rectangular shape in a front view with the plurality of fins 61b₂, and fixing the upper tank 61c₂ on the upper side thereof and the lower tank 61d₂ on the lower side thereof. The radiator 61H is arranged on an outlet 70b side of the boom 18, as described below, and is connected to an electrical element with high control temperature, for example, an inverter 22, among electrical elements of the VTOL rotor 20. Operation of the pump 62H described below causes the coolant fluid having been heated by circling through the inverter 22 to be fed to the upper tank 61c₂ via the tube 64H, to be cooled by flowing downward through each of the plurality of tubes 61a₂ and sent to the lower tank 61d₂, and to be sent to the inverter 22 via the tube 65H.

Note that, the control temperature is a temperature range or the limit temperature within which the electrical elements of the VTOL rotor 20 can continuously operate, and may be an upper limit temperature of the electrical element during normal operation, for example.

The two fans 61e are common fans for sending airflow to the plurality of fins 61b₁, 61b₂ of the two radiators 61L, 61H. The two fans 61e are operated to feed, from one side (the right-hand side in FIG. 2C) of the radiator 61, the airflow taken in from the inlet 70a to cause it to contact the plurality of fins 61b₁, 61b₂ of the radiators 61L, 61H, thereby causing heat exchange between the airflow and the radiators 61L, 61H. The heated airflow is leaked and discharged from the other side (the left-hand side in FIG. 2C) of the radiator main body.

The two pumps 62L, 62H are respectively connected to the radiators 61L, 61H via the tubes 65L, 65H, are configured to receive the cooled coolant fluid therefrom, and feed the same to the motor 21 and the inverter 22. In accordance with this, the coolant fluid having been heated through the motor 21 and the inverter 22 is fed to the radiators 61L, 61H via the tubes 64L, 64H, respectively.

The coolant fluid tank 63 is a container for storing the coolant fluid. For example, in a case where there is a shortage of the coolant fluid, the coolant fluid is sent from the coolant fluid tank 63 to the cooling circuit to supplement the coolant fluid.

The tubes 64L, 64H, 65L, 65H are members for transporting the coolant fluid, and connect the radiators 61L, 61H and the pumps 62L, 62H to the motor 21 and the inverter 22 to constitute a cooling circuit through which the coolant fluid circles.

FIG. 2D illustrates an example of the cooling circuit configured by the cooling system 60. In the present embodiment, a parallel-type cooling circuit for cooling each of the motor 21 and the inverter 22 of one VTOL rotor 20 is configured by the two radiators 61L, 61H. The upper tanks 61c₁, 61c₂ of the radiators 61L, 61H are resepectively connected to the motor 21 and the inverter 22 by the two tubes 64L, 64H, respectively. In addition, the lower tanks 61d₁, 61d₂ of the radiators 61L, 61H are respectively connected to the motor 21 and the inverter 22 via the pumps 62L, 62H by the two tubes 65L, 65H. The coolant fluid tank 63 is connected to the two tubes 65L, 65H. Here, the radiators 61L, 61H are respectively arranged on the inlet 70a side and the outlet 70b side while overlapping to oppose the discharge plane of the radiator 61L and the suction plane of the radiator 61H.

When the pump 62L is operated, the coolant fluid having been heated at the motor 21 is sent to the radiator 61L via the tube 64L, and the coolant fluid having been cooled at the radiator 61L is sent to the motor 21 via the tube 65L. On the other hand, when the pump 62H is operated, the coolant fluid having been heated at the inverter 22 is sent to the radiator 61H via the tube 64H, and the coolant fluid having been cooled at the radiator 61H is sent to the inverter 22 via the tube 65H.

Here, when the two fans 61e are operated, the airflow taken in from the inlet 70a is heated by first being in contact with the radiator 61L positioned at the inlet 70a side to perform heat exchange, and then, it is further heated by being in contact with the radiator 61H positioned at the outlet 70b side to perform heat exchange, and then is discharged from the outlet 70b. At this time, an electric element with low control temperature is cooled by the radiator 61L of which the operation temperature becomes relatively lower by making contact with the airflow first to be cooled, and an electric element with high control temperature is cooled by the radiator 61H of which the operation temperature becomes relatively higher by coming into contact with the airflow later to be cooled, thereby the electrical elements of the VTOL rotor 20, that is, the motor 21 and the inverter 22 can be efficiently cooled.

Note that, a cooling system having a configuration similar to that of the cooling system 60 may be provided to cool the electrical components of the cruising rotor 29.

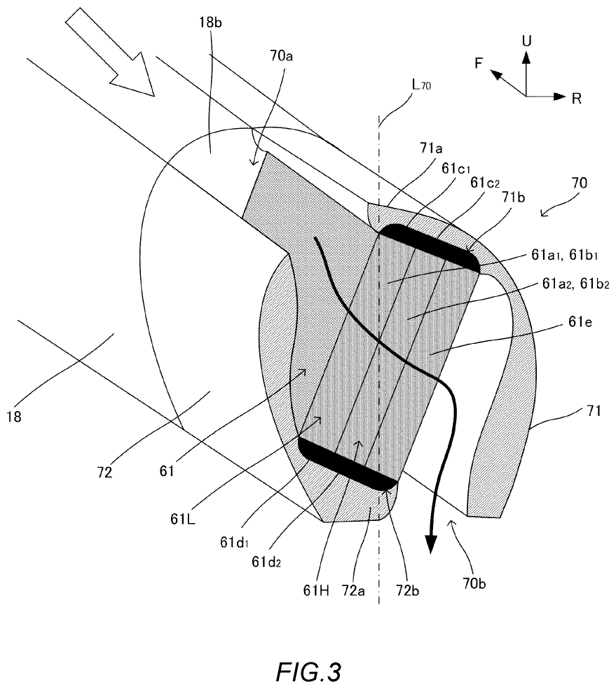

FIG. 3 illustrates a cross-sectional structure of an airflow guide structure 70 relative to reference line CC in FIG. 2A. Note that, the central axis relative to the width direction of the airflow guide structure 70 is defined as the central axis L₇₀. The central axis L₇₀ is parallel to the rotational axis 21a of the VTOL rotor 20, and is overlapped with the rotational axis 21a in the front-back direction at the same position with respect to the width direction. The airflow guide structure 70 is a structure provided in a part of the boom 18 for guiding airflow generated by rotation of the one or more blades 23 into the radiator 61 within the boom 18, and includes an upper structure body 71 and a lower structure body 72.

The upper structure body 71 is a member having a substantially reversed L-shaped cross section forming an upper edge and a right-side edge by being inserted into the barrel of the boom 18. The upper structure body 71 may be molded to be solid, the end of the upper edge is tilted in an upper-left direction, a recess 71b extending obliquely downward in a front-back direction is formed on a lower surface of the upper edge, and the inner surface of the right-side edge (that is, the left surface) is molded to be in a streamline shape expanding rightward from the recess 71b on a plane that is orthogonal to the front-back direction, and returning leftward to some extent to extend downward therefrom. The upper edge of the upper structure body 71 functions as a beam 71a installed on the upper side of the inlet 70a formed between the upper structure body 71 and the lower structure body 72. In this manner, the bending stress applied to the boom 18 including the airflow guide structure 70 can be resisted.

The lower structure body 72 is a member having a substantially L-shaped cross section forming a lower edge and a left-side edge by being inserted into the barrel of the boom 18. The lower structure body 72 may be molded to be solid, and a recess 72b extending obliquely upward in a front-back direction is formed on a upper plane of the lower edge, the right end of the lower edge faces downward, the upper end of the left-side edge is tilted toward the upper-left direction, and the inner surface of the left-side edge (that is, the right surface) is molded to be in a streamline shape expanding rightward to some extent from the upper end on a plane that is orthogonal to the front-back direction, and returning leftward to some extent to extend downward therefrom. The lower edge of the lower structure body 72 functions as a beam 72a installed on the lower side of the outlet 70b formed between the upper structure body 71 and the lower structure body 72. In this manner, the bending stress applied to the boom 18 including the airflow guide structure 70 can be resisted.

By assembling the airflow guide structure 70 by using the upper structure body 71 and the lower structure body 72 having the configurations described above, an inlet 70a for taking in the airflow is formed on the upper side and an outlet 70b for letting out the airflow is formed on the lower side within the boom 18. First, the two radiators 61L, 61H and the fan 61e are stacked, then, the upper structure body 71 is fixed to the spar 18c, the upper tanks 61c₁, 61c₂ of the two radiators 61L, 61H are engaged into the recess 71b of the upper structure body 71 and a bracket provided in the upper tanks 61c₁, 61c₂ are fixed to the spar 18c. Then, the lower structure body 72 is fixed to the spar 18c, the lower tanks 61d₁, 61d₂ of the radiators 61L, 61H are engaged into the recess 72b of the lower structure body 72 and a bracket provided in the lower tanks 61d₁, 61d₂ are fixed to the spar 18c. In this manner, the airflow guide structure 70 is integrally assembled in the barrel of the boom 18. At this time, the two radiators 61L, 61H and the fan 61e are supported between the two ribs 18b within the boom 18 by using the support member 61f.

In this manner, the inlet 70a is formed to be positioned on the side of one plane (suction plane) of the radiators 61L, 61H between the upper edge of the upper structure body 71 and the left-side edge of the lower structure body 72, and the outlet 70b is formed to be positioned on a side of the other plane (discharge plane) of the radiators 61L, 61H between the right-side edge of the upper structure body 71 and the lower edge of the lower structure body 72. At the same time, the radiators 61L, 61H will be respectively arranged on the inlet 70a side and the outlet 70b side between the inlet 70a and the outlet 70b within the boom 18, and are overlapped with respect to a direction that is parallel to the rotational axis 21a (that is, the central axis L₇₀) of the VTOL rotor 20 and provided to be tilted with its suction plane facing toward the inlet 70a side and its discharge plane facing toward the outlet 70b side, with respect to the central axis 1_70. Further, two fans 61e are arranged on the discharge plane side of the radiator 61H. Note that, the two fans 61e may be arranged don the suction plane side of the radiator 61. In this manner, the airflow taken in from the inlet 70a will contact the two radiators 61L, 61H successively.

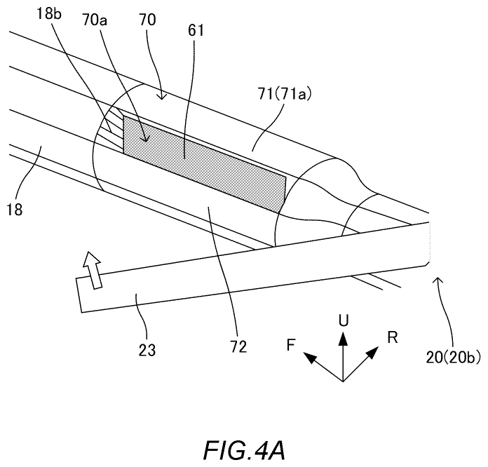

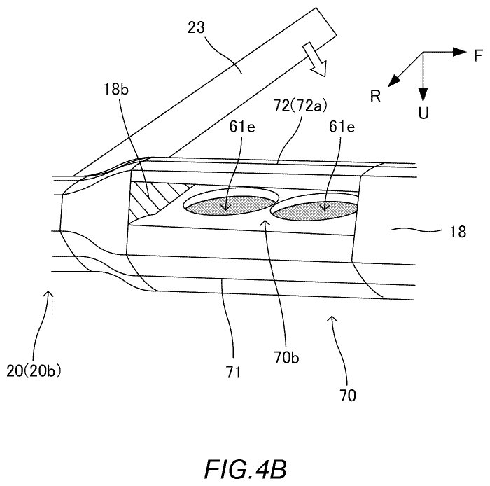

FIG. 4A illustrates a configuration of the upper side of the airflow guide structure 70 provided in the boom 18. The airflow guide structure 70 is a structure including a radiator 61 for cooling the VTOL rotor 20b on the right-hand side, as an example, and is provided in the boom barrel between the rotational axes 21a of the two VTOL rotors 20a, 20b (that is, the front side of the VTOL rotor 20b). By the airflow guide structure 70, the inlet 70a is provided between the rotational axes 21a of the two VTOL rotors 20a, 20b on the surface of the boom 18, and is provided on a side that faces toward the rotational direction (rightward in the present example) of the one or more blades 23, that is, the opposite side with respect to the rotational direction (left-hand side in the present example), with respect to the rotational axis 21a (the central axis L₇₀) of the VTOL rotor 20b in the front view, of a surface of the boom 18 positioned below the plane of rotation of the one or more blades 23 of at least one of the two VTOL rotors 20a, 20b, particularly the VTOL rotor 20b in the present example.

Here, the blade 23 of the VTOL rotor 20 has a pitch angle with respect to the plane of rotation to generate thrust (see FIG. 2A). Therefore, when the blade 23 rotates in a clockwise direction as illustrated in FIG. 4A, for example, an airflow is generated in a direction that is tilted toward the rotational movement direction of the blade 23 with respect to the downward direction, that is, the lower-right direction (the direction of the outlined arrow in FIG. 3). Accordingly, in the airflow guide structure 70, providing the inlet 70a on the left-hand side with respect the rotational axis 21a (the central axis L₇₀) of the VTOL rotor 20b in the front view can cause the airflow generated by rotation of the or more blades 23 of at least one rotor, particularly the VTOL rotor 20b in the present example to be efficiently guided to the radiator 61 within the boom 18 via the inlet 70a, when the two VTOL rotors 20a, 20b are activated.

In addition, as illustrated in FIG. 3, since the end on the upper edge of the upper structure body 71 of the airflow guide structure 70 is tilted toward the upper-left direction and the upper end of the left-side edge of the lower structure body 72 is tilted toward the upper-left direction, having the end of the upper edge of the upper structure body 71 and the upper end of the left-side edge of the lower structure body 72 opposing each other in the airflow guide structure 70 causes the inlet 70a to be provided to face toward the rotational direction (rightward in FIG. 3) of the blade 23 of the VTOL rotor 20b with respect to the central axis L₇₀ while being tilted toward the upper-left direction. In this manner, the airflow generated by rotation of the one or more blades 23 of the VTOL rotor 20b can be efficiently guided to the radiator 61 within the boom 18 via the inlet 70a.

Note that, the airflow guide structure 70 with respect to the VTOL rotor 20b may further be provided in the boom barrel between the rotational axes 21a of the two VTOL rotors 20b, 20c (that is, on the rear side of the VTOL rotor 20b), instead of or in addition to the boom barrel of the rotational axes 21a between the two VTOL rotors 20a, 20b. In such a case, the airflow guide structure 70 is provided is provided on a side that faces toward the rotational direction (leftward in the present example) of the one or more blades 23, that is, the opposite side with respect to the rotational direction (right-hand side in the present example), with respect to the rotational axis 21a (the central axis L₇₀) of the VTOL rotor 20b in the front view, of a surface of the boom 18 positioned below the plane of rotation of the one or more blades 23 of at least one of the two VTOL rotors 20b, 20c, particularly the VTOL rotor 20b in the present example. In addition, the inlet 70a is provided to be tilted toward the upper-right direction facing toward the rotational direction (leftward in the present example) of the blade 23 of the VTOL rotor 20b with respect to the central axis L₇₀. In this manner, the airflow generated by rotation of the one or more blades 23 of the VTOL rotor 20b can be efficiently guided to the radiator 61 within the boom 18 via the inlet 70a.

FIG. 4B illustrates a configuration of the lower side of the airflow guide structure 70 described above. By the airflow guide structure 70, the outlet 70b is provided at a position opposing the inlet 70a on the lower side of the boom 18. In this manner, the airflow introduced via the inlet 70a on the upper side is discharged downward from the outlet 70b on the lower side through the inside of the boom 18, thereby enabling the airflow to efficiently pass through the inside of the boom 18.

The outlet 70b is provided, of the lower portion of the boom 18, in the front view, on a side that follows the rotational direction (rightward in the present example) of the one or more blades 23 with respect to the rotational axis 21a (the central axis L₇₀) of the VTOL rotor 20b in the present example, that is, a side corresponding to the rotational direction (the right-hand side in the present example). That is, the outlet is positioned on a side that is opposite from the inlet 70a with respect to the rotational axis 21a (the central axis L₇₀) of the VTOL rotor 20b, of the lower portion of the boom 18. In this manner, the flow channel within the boom 18 of the airflow introduced via the inlet 70a becomes longer so that the airflow is in contact with the radiator 61 for a long distance before being drawn out from the outlet 70b, thereby enabling the radiator 61 to be efficiently cooled.

In addition, as illustrated in FIG. 3, since the right end on the lower edge of the lower structure body 72 of the airflow guide structure 70 faces downward and the left-inner surface on the right-side edge of the upper structure body 71 is molded in a streamline shape facing downward, the right end on the lower edge of the lower structure body 72 and the lower end on the right-side edge of the upper structure body 71 opposes in the airflow guide structure 70, so that the outlet 70b faces further downward with respect to the inlet 70a that is provided to tilt toward the upper-left direction. In this manner, the airflow that is introduced inside the boom 18 toward the lower-right direction via the inlet 70a is drawn out further downward via the outlet 70b, thereby enabling the thrust in the vertical direction applied to the boom 18 (that is, the aircraft body of the aircraft 100) to be increased. In addition, the structure of such a airflow guide structure 70 enables the output of the fan 61e to be used as the thrust in the vertical direction applied to the boom 18 (that is, the aircraft body).

The airflow guide structure 70 (that is, the radiator 61) can be placed at any position relative to the front-back direction within the boom 18. For example, between the rotational axis 21a of the VTOL rotors 20a, 20b, an airflow guide structure 70 including the radiator 61 for cooling the VTOL rotor 20a can be provided at the rear side thereof, and an airflow guide structure 70 including the radiator 61 for cooling the VTOL rotor 20b can be provided on the front side thereof. In addition, between the rotational axis 21a of the VTOL rotors 20b, 20c, an airflow guide structure 70 including the radiator 61 for cooling the VTOL rotor 20b can be provided at the rear side thereof, and an airflow guide structure 70 including the radiator 61 for cooling the VTOL rotor 20c can be provided on the front side thereof. In addition, between the rotational axis 21a of the VTOL rotors 20c, 20d, an airflow guide structure 70 including the radiator 61 for cooling the VTOL rotor 20c can be provided at the rear side thereof, and an airflow guide structure 70 including the radiator 61 for cooling the VTOL rotor 20d can be provided on the front side thereof. Note that, the radiator 61 for cooling the VTOL rotor 20b may be placed only at one of the front side or the rear side thereof. The radiator 61 for cooling the VTOL rotor 20c may be placed only at one of the front side or the rear side.

Alternatively, one airflow guide structure 70 including a radiator 61 for cooling the VTOL rotors 20a, 20b can be provided at a placement position between the rotational axis 21a thereof, one airflow guide structure 70 including a radiator 61 for cooling the VTOL rotors 20b, 20c can be provided at a placement position between the rotational axis 21a thereof, and one airflow guide structure 70 including a radiator 61 for cool the VTOL rotors 20c, 20d can be provided at a placement position between the rotational axis 21a thereof. These placement position is suitable as a location to place the airflow guide structure 70 including two radiators when a parallel-type cooling circuit is configured in which two adjacent VTOL rotors 20 are cooled at the same time.

Note that, the placement position of the airflow guide structure 70 may be a location where the boom 18 is at least partially connected to the front wing 14, thereby allowing the airflow guide structure 70 to be fixed to the boom 18 more stably by using the frame of the front wing 14 or the like. In addition, the placement position of the airflow guide structure 70 may be the barrel of the boom 18 supported between the front wing 14 and the rear wing 16, thereby allowing the airflow guide structure 70 to be fixed more stably to the boom 18. In addition, the placement position of the airflow guide structure 70 may be a location where the boom 18 is at least partially connected to the rear wing 16, thereby allowing the airflow guide structure 70 to be fixed to the boom 18 more stably by using the frame of the rear wing 16 or the like.

In addition, the airflow guide structure 70 (that is, the radiator 61) may be placed between the rotational axes 21a of two adjacent VTOL rotors 20, the rotational directions of which are opposite, and the blades 23 perform rotational movement in the same direction between the respective rotational axes 21a. In this manner, when at least one of the two adjacent VTOL rotors 20 is activated, the airflow generated by rotation of the one or more blades 23 os said one rotor, preferably both rotors can be efficiently guided to the radiator 61 within the boom 18 via the inlet 70a of the airflow guide structure 70.

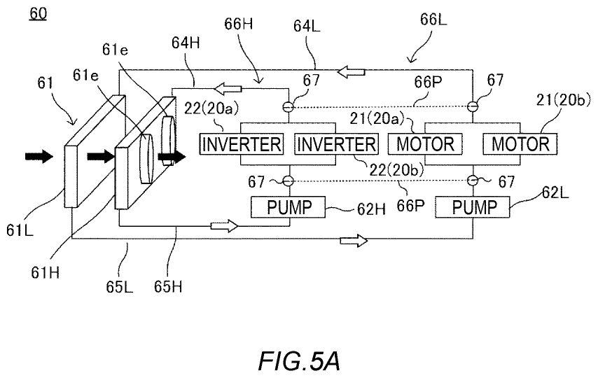

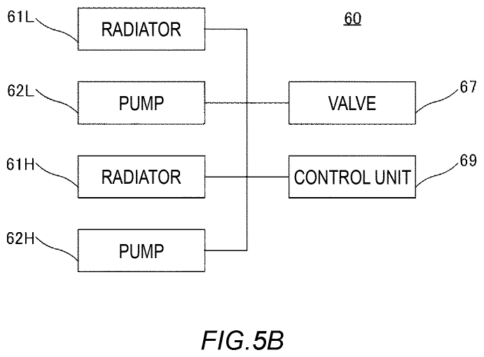

FIG. 5A illustrates another example of the cooling circuit configured by the cooling system 60. The cooling system 60 of the present example constitutes a parallel-type cooling circuit that cools a plurality of VTOL rotors 20 by using two radiators 61L, 61H, more specifically, cools in parallel an electric element with low control temperature, for example, the motor 21, of each of the two VTOL rotors 20 by using the radiator 61L, and cools in parallel an electric element with high control temperature, for example, the inverter 22, of each of the two VTOL rotors 20 by using the radiator 61H. As an example, a cooling circuit that cools the motor 21 and the inverter 22 of the two VTOL rotors 20a, 20b with the radiators 61 (two radiators 61L, 61H) arranged within the boom 18 between the rotational axes 21a of the two VTOL rotors 20a, 20b will be described. Note that, illustration of the coolant fluid tank 63 is omitted.

The cooling system 60 of the present example includes the radiator 61L, the motors 21 of the two VTOL rotors 20a, 20b, the pump 62L for supplying coolant fluid to the two motors 21, the tube 64L, 65L for connecting them (the flow path configured by the tube connected to the radiator 61L is defined as the first flow path 66L), the radiator 61H, the inverters 22 of the two VTOL rotors 20a, 20b, the pump 62H for supplying coolant fluid to the two inverters 22, the tubes 64H, 65H for connecting them (the flow path configured by the tube connected to the radiator 61H is defined as the second flow path 66H), two third flow paths 66P for connecting the two motors 21 in the first flow path 66L and the two inverters 22 in the second flow path 66H in parallel, and four valves 67 for opening and closing the two third flow paths 66P with respect to the first flow path 66L and the second flow path 66H.

The upper tanks 61c₁, 61c₂ of the radiators 61L, 61H are respectively connected to the motor 21 and the inverter 22 of the VTOL rotors 20a, 20b by the two tubes 64L, 64H. In addition, the lower tanks 61d₁, 61d₂ of the radiators 61L, 61H are respectively connected to the motor 21 and the inverter 22 of the VTOL rotors 20a, 20b via the pumps 62L, 62H by the two tubes 65L, 65H. In this manner, the two motors 21 of the VTOL rotors 20a, 20b are connected in parallel to the radiator 61L via the pump 62L, and the two inverters 22 of the VTOL rotors 20a, 20b are connected in parallel to the radiator 61H via the pump 62H. Here, the radiators 61L, 61H are respectively arranged on the inlet 70a side and the outlet 70b side while overlapping to oppose the discharge plane of the radiator 61L and the suction plane of the radiator 61H.

Further, the third flow path 66P is connected via the valve 67 between the tube 64L of the first flow path 66L and the tube 64H of the second flow path 66H, and the third flow path 66P is connected via the valve 67 between the tube 65L of the first flow path 66L and the tube 65H of the second flow path 66H. In this manner, the inverter 22 can be connected in parallel to the motor 21 within the first flow path 66L or the motor 21 can be connected in parallel to the inverter 22 within the second flow path 66H via the third flow path 66P by opening and closing the valve 67, and in a case where a failure oocurs in the radiator or the pump of one of the radiator 61L and the pump 62L, and the radiator 61H and the pump 62H, the motor 21 and the inverter 22 can be can be cooled by the other radiator or the pump.

FIG. 5B illustrates a configuration of a control system of the cooling system 60 according to the present example. The control system includes a sensor provided in each of the two radiators 61L, 61H, a sensor provided in each of the two pumps 62L, 62H, four valves 67, and a control unit 69.

The four sensors may be sensors for detecting a stop of the radiators 61L, 61H and the pumps 62L, 62H, for example. In addition, it may be a sensor for determining an abnormality by detecting the state of the coolant fluid such as the pressure, temperature, flow rate of the coolant fluid flowing therethrough. Note that, the detection result is sent to the control unit 69.

The four valves 67 are selector valves that connect the tubes 64L, 64H, 65L, 65H, the tube of the third flow path 66P, and the motor 21 or the inverter 22 in a switchable manner, and a three-way selector valve can be employed, for example. The valve 67 is controlled by the control unit 69 to be operated.

The control unit 69 is a computer apparatus that realizes the control functions of the cooling system 60 by activating a control program. The control unit 69 receives a detection signal from a sensor provided in each of the two radiators 61L, 61H and the two pumps 62L, 62H, in a case where no abnormality is detected, opens and closes the valve 67 to close the two third flow paths 66P and separates the first flow path 66L and the second flow path 66H, and in a case where an abnormality is detected in any of the two radiators 61L, 61H and the two pumps 62L, 62H, opens and closes the four valves 67 to open the two third flow path 66P and close the second flow path 66H and connects the inverter 22 in parallel to the motor 21 within the first flow path 66L, or closes the first flow path 66L and connects the motor 21 in parallel to the inverter 22 within the second flow path 66H.

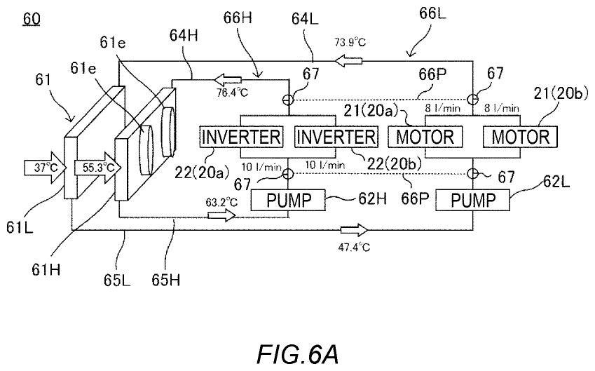

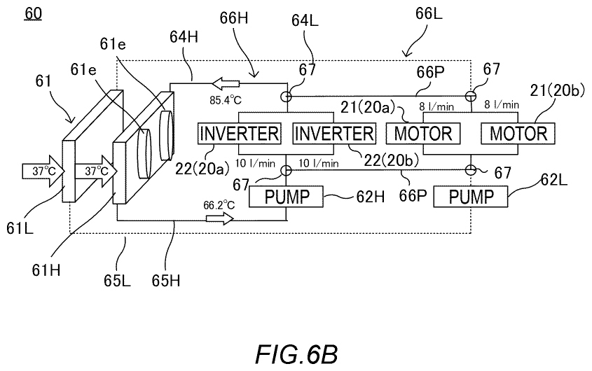

FIG. 6A illustrates an example of an operation of the cooling circuit of the cooling system 60 of the present example. It is assumed that the aircraft 100 is ascending with eight VTOL rotors 20 operating. The pump 62L is operated by the control unit 69, the coolant fluid (for example, 73.9° C.) having been heated at the motors 21 of the VTOL rotors 20a, 20b is sent to the radiator 61L via the tube 64L, and the coolant fluid (for example, 47.4° C.) having been cooled at the radiator 61L is sent to the motors 21 of the VTOL rotors 20a, 20b via the tube 65L at a flow rate of 8 liters/minute, for example. The pump 62H is operated by the control unit 69, the coolant fluid (for example, 76.4° C.) having been heated at the inverters 22 of the VTOL rotors 20a, 20b is sent to the radiator 61H via the tube 64H, and the coolant fluid (for example, 63.2° C.) having been cooled at the radiator 61H is sent to the inverters 22 of the VTOL rotors 20a, 20b via the tube 65H at a flow rate of 10 liters/minute, for example.

Here, the two fans 61e are operated, the airflow (to 37° C., for example) taken in from the inlet 70a is heated (to 55.3° C., for example) by first being in contact with the radiator 61L positioned at the inlet 70a side to perform heat exchange, and then, it is further heated by being in contact with the radiator 61H positioned at the outlet 70b side to perform heat exchange, and then is discharged from the outlet 70b. At this time, the radiator 61L, the operation temperature of which becomes relatively lower by making contact with the airflow first to be cooled, cools an electric element with low control temperature, that is, the motor 21, and the radiator 61H, the operation temperature of which becomes relatively higher by coming into contact with the airflow later to be cooled, cools an electric element with high control temperature, that is, the inverter 22, thereby enabling the electrical elements of the VTOL rotor 20, that is, the motor 21 and the inverter 22 to be efficiently cooled.

FIG. 6B illustrates another example of an operation of the cooling circuit of the cooling system 60 of the present example. It is assumed that the radiator 61L has abnormally stopped while the aircraft 100 is ascending with eight VTOL rotors 20 operating. When an abnormality of the radiator 61L is detected, the control unit 69 stops the pump 62L, and opens and closes the four valves 67 to open the two third flow paths 66P and close the first flow path 66L, thereby connecting the motor 21 in parallel to the inverter 22 within the second flow path 66H. The pump 62H is then operated by the control unit 69, the coolant fluid (for example, 85.4° C.) having been heated at the motors 21 and the inverters 22 of the VTOL rotors 20a, 20b is sent to the radiator 61H via the tube 64H, and the coolant fluid (for example, 66.2° C.) having been cooled at the radiator 61H is sent to the motors 21 and the inverters 22 of the VTOL rotors 20a, 20b via the tube 65H at a flow rate of 8 liters/minute and 10 liters/minute, respectively, for example. In this case, since the amount of the coolant flowing through the radiator 61H is increased, and the thermal conductivity inside the radiator is improved, increase in the temperature of the motor 21 and the inverter 22 can be minimized even if an abnormality of the radiator 61L occurs.

Here, the two fans 61e are operated, so that the airflow (for example, 37° C.) taken in from the inlet 70a passes through the radiator 61L on the inlet 70a side that is stopped without performing heat exchange, is then heated by contacting the radiator 61H on the outlet 70b side to perform heat exchange, and discharged from the outlet 70b.

On the other hand, when the radiator 61H abnormally stops while the aircraft 100 is ascending with eight VTOL rotors 20 operating and the abnormality of the radiator 61H is detected, the control unit 69 stops the pump 62H, and opens and closes the four valves 67 to open the two third flow paths 66P and close the second flow path 66H, thereby connecting the inverter 22 in parallel to the motor 21 within the first flow path 66L. The pump 62L is then operated by the control unit 69, the coolant fluid having been heated at the motors 21 and the inverters 22 of the VTOL rotors 20a, 20b is sent to the radiator 61L via the tube 64L, and the coolant fluid having been cooled at the radiator 61L is sent to the motors 21 and the inverters 22 of the VTOL rotors 20a, 20b via the tube 65L.

Here, the two fans 61e are operated, so that the airflow taken in from the inlet 70a is heated by contacting the radiator 61L on the inlet 70a side to perform heat exchange, and then passes through the radiator 61H on the outlet 70b side that is stopped without performing heat exchange, and is discharged from the outlet 70b.

As such, by connecting the inverter 22 in parallel to the motor 21 within the first flow path 66L or by connecting the motor 21 in parallel to the inverter 22 within the second flow path 66H via the third flow path 66P by opening and closing the valve 67, in a case where a failure oocurs in the radiator or the pump of one of the radiator 61L and the pump 62L, and the radiator 61H and the pump 62H, the motor 21 and the inverter 22 of the two VTOL rotors 20 can be can be cooled by the other radiator or the pump.

Similarly, a cooling circuit that cools the motor 21 and the inverter 22 of the two VTOL rotors 20b, 20c with the radiators 61 (two radiators 61L, 61H) arranged within the boom 18 between the rotational axes 21a of the two VTOL rotors 20b, 20c may be configured. In addition, a cooling circuit that cools the motor 21 and the inverter 22 of the two VTOL rotors 20c, 20d with the radiators 61 (two radiators 61L, 61H) arranged within the boom 18 between the rotational axes 21a of the two VTOL rotors 20c, 20d may be configured.

Note that, a cooling system configured similarly to the cooling system 60 may be provided to cool electric elements of the cruising rotor 29.

The cooling system 60 according to the present embodiment is a system, in an aircraft 100 including at least one VTOL rotor 20 that generates thrust in a vertical direction during take-off and landing, for cooling the VTOL rotor 20 by using the airflow generated by rotation of one or more blades 23 of the at least one VTOL rotor 20, wherein the cooling system 60 has two radiators 61L, 61H stored between an inlet 70a and an outlet 70b provided in the boom 18 within the boom 18 that supports the one or more blades 23 upwardly, and cools an electric element with low control temperature and an electric element with high control temperature, among the electric elements of the at least one VTOL rotor 20, by using a radiator 61L positioned at the inlet 70a side and a radiator 61H positioned at the outlet 70b side among the two radiators 61L, 61H, respectively. Accordingly, with the cooling system 60, among the two radiators 61L, 61H stored between the inlet 70a and the outlet 70b provided in the boom 18 within the boom 18, the radiator 61L that is positioned on the inlet 70a side, the operation temperature of which becomes lower by being in contact with the airflow taken in from the inlet 70a first to be cooled, cools the electric element with low control temperature, for example, the motor 21 of the VTOL rotor 20, and the radiator 61H that is positioned on the outlet 70b side, the operation temperature of which becomes higher by being in contact with the airflow that has passed the radiator 61L next to be cool, cools the electric element with high control temperature, for example, the inverter 22, thereby enabling the motor 21 and the inverter 22 of the VTOL rotor 20 to be efficiently cooled.

In addition, the aircraft 100 according to the present embodiment includes a fuselage 12, a front wing 14 and a rear wing 16 that extends laterally from the fuselage 12 and is configured to generate lift during cruise, a boom 18 extending in a front-back direction that is supported by the front wing 14 and a rear wing 16 to be spaced apart from the fuselage 12, at least one VTOL rotor 20 that is supported on the boom 18, the at least one VTOL rotor 20 having one or more blades 23 configured to generate thrust in a vertical direction during take-off and landing, and a cooling system 60 within the boom 18, the cooling system 60 including two radiators 61L, 61H stored between an inlet 70a and an outlet 70b provided on the boom 18, and being configured to cool an element with a low control temperature and an element with a high control temperature, respectively, among electric elements of the at least one VTOL rotor by using the radiator 61L that is positioned on the inlet 70a side and the radiator 61H that is positioned on the outlet 70b side among the two radiators 61L, 61H. Accordingly, with the cooling system 60, among the two radiators 61L, 61H stored between the inlet 70a and the outlet 70b provided in the boom 18 within the boom 18, the radiator 61L that is positioned on the inlet 70a side, the operation temperature of which becomes lower by being in contact with the airflow taken in from the inlet 70a first to be cooled, cools the electric element with low control temperature, for example, the motor 21 of the VTOL rotor 20, and the radiator 61H that is positioned on the outlet 70b side, the operation temperature of which becomes higher by being in contact with the airflow that has passed the radiator 61L next to be cool, cools the electric element with high control temperature, for example, the inverter 22, thereby enabling the motor 21 and the inverter 22 of the VTOL rotor 20 to be efficiently cooled.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An aircraft comprising:
a fuselage;
a wing body that extends laterally from the fuselage and is configured to generate lift during cruise;
a boom extending in a front-back direction that is supported by the wing body to be spaced apart from the fuselage;
at least one rotor that is supported on the boom, the at least one rotor having one or more blades configured to generate thrust in a vertical direction during take-off and landing; and
a cooling system within the boom, the cooling system including two radiators stored between an inlet and an outlet provided on the boom, and being configured to cool an element with a low control temperature and an element with a high control temperature, respectively, among elements of the at least one rotor by using a first radiator that is positioned on the inlet side and a second radiator that is positioned on the outlet side among the two radiators.

2. The aircraft according to claim 1, wherein
the at least one rotor includes a rotational apparatus that is stored in the boom and is configured to rotate the one or more blades, and a control apparatus configured to control the rotational apparatus; and
the element with low control temperature and the element with high control temperature are the rotational apparatus and the control apparatus, respectively.

3. The aircraft according to claim 2 wherein
the at least one rotor includes two rotors, and
the cooling system is configured to cool the rotational apparatus of each of the two rotors by using the first radiator, and to cool a control apparatus of each of the two rotors by using the second radiator.

4. The aircraft according to claim 2, wherein
the cooling system includes a first flow path for connecting the first radiator, the rotational apparatus, and a first pump that supplies coolant fluid to the rotational apparatus, a second flow path for connecting the second radiator, the control apparatus, and a second pump that supplies coolant fluid to the control apparatus, a third flow path for connecting the rotational apparatus within the first flow path and the control apparatus within the second flow path in parallel, and a valve configured to open and close the third flow path with respect to the first flow path and the second flow path.

5. The aircraft according to claim 3, wherein
the cooling system includes a first flow path for connecting the first radiator, the rotational apparatus, and a first pump that supplies coolant fluid to the rotational apparatus, a second flow path for connecting the second radiator, the control apparatus, and a second pump that supplies coolant fluid to the control apparatus, a third flow path for connecting the rotational apparatus within the first flow path and the control apparatus within the second flow path in parallel, and a valve configured to open and close the third flow path with respect to the first flow path and the second flow path.

6. The aircraft according to claim 5, further comprising a control unit configured to detect abnormality of at least one of the first radiator, the first pump, the second radiator, or the second pump, and to open and close the valve based on a detection result.

7. The aircraft according to claim 1, wherein the two radiators are arranged to be stacked with respect to a direction that is parallel to a rotational axis of the at least one rotor.

8. The aircraft according to claim 2, wherein the two radiators are arranged to be stacked with respect to a direction that is parallel to a rotational axis of the at least one rotor.

9. The aircraft according to claim 3, wherein the two radiators are arranged to be stacked with respect to a direction that is parallel to a rotational axis of the at least one rotor.

10. The aircraft according to claim 4, wherein the two radiators are arranged to be stacked with respect to a direction that is parallel to a rotational axis of the at least one rotor.

11. The aircraft according to claim 6, wherein the two radiators are arranged to be stacked with respect to a direction that is parallel to a rotational axis of the at least one rotor.

12. The aircraft according to claim 1, wherein the cooling system further includes a common fan configured to send airflow to the two radiators.

13. The aircraft according to claim 2, wherein the cooling system further includes a common fan configured to send airflow to the two radiators.

14. The aircraft according to claim 3, wherein the cooling system further includes a common fan configured to send airflow to the two radiators.

15. The aircraft according to claim 4, wherein the cooling system further includes a common fan configured to send airflow to the two radiators.

16. The aircraft according to claim 6, wherein the cooling system further includes a common fan configured to send airflow to the two radiators.

17. The aircraft according to claim 1, wherein the inlet is provided in a region below a plane of rotation of the at least one rotor on a surface of the boom.

18. The aircraft according to claim 2, wherein the inlet is provided in a region below a plane of rotation of the at least one rotor on a surface of the boom.

19. The aircraft according to claim 3, wherein the inlet is provided in a region below a plane of rotation of the at least one rotor on a surface of the boom.

20. The aircraft according to claim 4, wherein the inlet is provided in a region below a plane of rotation of the at least one rotor on a surface of the boom.
